(19) United States
(12) Patent Application Publication
(10) Pub. No.: US 2015/0015679 A1
(43) Pub. Date: Jan. 15, 2015

(54) AUTOSTEREOSCOPIC DISPLAY SYSTEM AND METHOD

(71) Applicant: HIMAX TECHNOLOGIES LIMITED, Tainan City (TW)

(72) Inventor: Kuo-Hao Lee, Tainan City (TW)

(21) Appl. No.: 13/942,458

(22) Filed: Jul. 15, 2013

(51) Int. Cl. H04N 13/04

(52) U.S. Cl. CPC H04N 13/0402
USPC 348/51

(57) ABSTRACT

An autostereoscopic display system includes a three-dimensional (3D) image converter configured to arrange a multiplicity of views, and a display device being coupled to receive the multiple arranged views. The arranged views include views arranged in forward order of view angle and views arranged in reverse order of view angle, the views in forward order and the views in reverse order being alternately arranged on each line of the display device.

### BACKGROUND OF THE INVENTION

1. Field of the Invention

The present invention generally relates to autostereoscopy, and more particularly to an autostereoscopic display system and method without view jump.

2. Description of Related Art

Autostereoscopy is a technique for displaying stereoscopic images without use of special glasses, and is also known as glasses-free 3D.

A glasses-free 3D technique primarily uses lenses specifically designed to respectively magnify views that are interlaced on a display device. A display device adopting the glasses-free 3D technique may give an illusion of depth or make images appear to change or move as the image is viewed from different angles.

A viewer watching a present-day glasses-free 3D display, however, oftentimes perceives annoying discontinuity in vision while moving from one side toward another side of the display.

For the reason that conventional autostereoscopic system could not smoothly display stereoscopic images, a need has arisen to propose a novel system to overcome the disadvantages of the conventional autostereoscopic system.

### SUMMARY OF THE INVENTION

In view of the foregoing, it is an object of the embodiment of the present invention to provide an autostereoscopic display system and method without view-jump so that a viewer may continuously perceive stereoscopic vision without annoyance.

According to one embodiment, an autostereoscopic display system includes a three-dimensional (3D) image converter, and a display device. The 3D image converter is coupled to receive a plurality of views of different view angles, and configured to arrange the plurality of views. The display device is coupled to receive the plurality of arranged views. The plurality of arranged views includes views arranged in forward order of view angle and views arranged in reverse order of view angle, the views in forward order and the views in reverse order being alternately arranged on each line of the display device.

### BRIEF DESCRIPTION OF THE DRAWINGS

FIG. 1 shows an autostereoscopic display system according to one embodiment of the present invention;

FIG. 2 shows a block diagram of the view generating device of FIG. 1;

FIG. 3 shows one possible arrangement of the views of different view angles provided by the 3D image converter and displayed on the display device of FIG. 1;

FIG. 4 shows an exemplary arrangement of the views of different view angles provided by the 3D image converter and displayed on the display device according to one embodiment of the present invention; and

FIG. 5 shows another exemplary arrangement of the views of different view angles provided, by the 3D image converter and displayed on the display device according to another embodiment of the present invention.

### DETAILED DESCRIPTION OF THE INVENTION

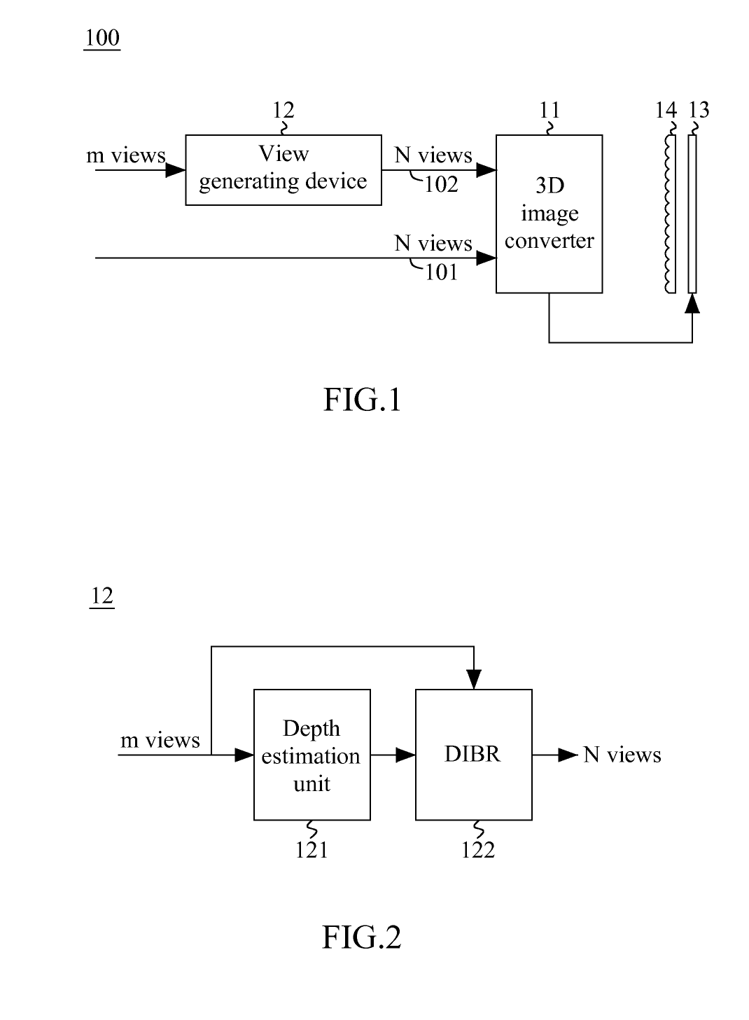

FIG. 1 shows an autostereoscopic display system 100 according to one embodiment of the present invention. The system 100 of the embodiment includes a three-dimensional (3D) image converter 11 that is coupled to receive plural views (say N views) of different view angles. The N views may be directly provided (via a path 101) by a specific camera that is capable of taking N views of different view angles. Alternately, the N views may be generated by a view generating device 12 that generates the N views based on fewer views or subset of views (say m views such as two views). The generated N views may then be provided (via a path 102) to the 3D image converter 11. The operations of the 3D image converter 11 and the view generating device 12 may be performed using a digital signal processor.

FIG. 2 shows a block diagram of the view generating device 12 of FIG. 1. In the embodiment, the view generating device 12 includes a depth estimation unit 121 that is coupled to receive and process the m views, therefore generating disparity information about the m views. Based on the disparity information, an image synthesizer such as a depth-image-based rendering (DIBR) unit 122 may accordingly generate the required N views. The operations of the depth estimation unit 121 and the DIBR unit 122 may be performed using a digital signal processor.

Referring back to FIG. 1, the 3D image converter 11 is configured to arrange the received N views and then forward the arranged views to a display device 13 such as a liquid crystal display (LCD) or light-emitting diode (LED) display. In front of the display device 13 is a lenticular lens array 14 that is composed of plural magnifying lenses, designed so that when viewed from slightly different angles, different views of different view angles are magnified respectively, therefore constructing an autostereoscopic display system 100 or a glasses-free 3D system that displays stereoscopic images without use of glasses or head-mounted units on viewers.

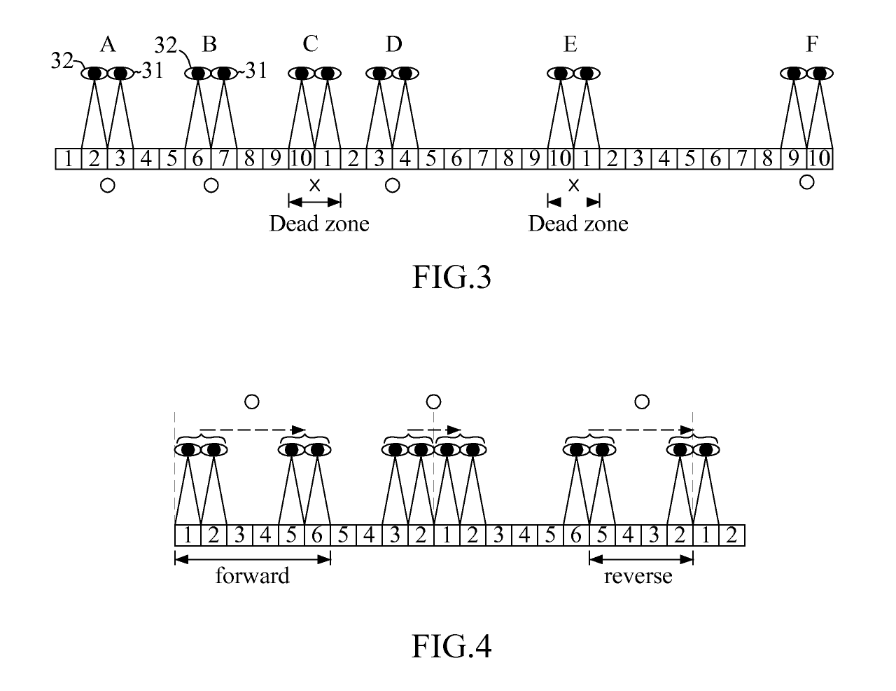

FIG. 3 shows one possible arrangement of the views of different view angles provided by the 3D image converter 11 and displayed on the display device 13 of FIG. 1. One (horizontal) line on the display device 13 is shown in FIG. 3. It is noted that other lines on the display device 13 may have the same views arrangement or similar views arrangement (e.g., an arrangement shifted from the shown line). In the example, ten views from a leftmost view angle to a rightmost view angle (represented by numerals 1 to 10) are arranged in order of view angle. Although the views from the leftmost view angle to the rightmost view angle are arranged and represented by numerals 1 to 10, it is appreciated that, in another example, the views may be arranged from a rightmost angle to a leftmost angle (represented by numerals 1 to 10). After arranging one set of views 1 to 10, another set or sets of views 1 to 10 are repeated and displayed on the remaining space of the line. When a viewer is in front of the display device 13 covered with the lenticular lens array 14, for example, at a position A, the viewer may perceive stereoscopic vision due to binocular disparity between view 2 and view 3, with viewer's right eye 31 directed to view 3 and viewer's left eye 32 directed to view 2 (to the left of view 3 on the display device).

It is observed, however, that an odd perception may be recognized by the viewer who is at a position C or E (indicated as dead zone). At this position, viewer's right eye 31 is directed to view 1 and viewer's left eye 32 is directed to view 10. The odd perception arises because viewer's right eye 31 is directed to view 1 to the right (rather than left) of view 10 of viewer's left eye 32. Moreover, view 1 and view 10 represent two extreme view angles, one to the leftmost and one to the rightmost. In other words, the disparity between view 1 and view 10 is too large to be perceived by the viewer as a stereoscopic vision. Accordingly, when the viewer is moving from left-hand side of the display device 13 toward right-hand side of the display device 13, the viewer may continuously perceive stereoscopic vision except at the positions C and E, where the viewer perceives view-jump, which is annoying to the eyes.

In order to improve the view-jump phenomenon as discussed above, the 3D image converter 11 of the embodiment provides a modified arrangement on the views of different view angles. FIG. 4 shows an exemplary arrangement of the views of different view angles provided by the 3D image converter 11 and displayed on the display device 13 according to one embodiment of the present invention. One (horizontal) line on the display device 13 is shown in FIG. 4. In the exemplary embodiment, six views, for example, from a left view angle toward a right view angle (represented by numerals 1 to 6) are arranged in (forward) order of view angle. After one set of views are arranged in forward order of view angle, another set of views (e.g., views 5 to 2) are subsequently arranged in reverse order of view angle. It is noted that, if the forward order of view angle is defined, as from left view angle toward right view angle, the reverse order of view angle is then defined as from right view angle toward left view angle, and vice versa. As shown in FIG. 4, views arranged in forward order (of view angle) and views arranged in reverse order (of view angle) are alternately arranged on a line of the display device 13.

According to the arrangement illustrated in FIG. 4, the viewer no longer perceives view-jump when the viewer is moving from left-hand side of the display device 13 toward right-hand side of the display device 13, for the reason that disparity between any two adjacent views is now less than a predetermined threshold that allows for perceiving the two adjacent views as a stereoscopic vision. Accordingly, when the viewer is moving from left-hand side of the display device 13 toward right-hand side of the display device 13, the viewer may continuously perceive stereoscopic vision without annoyance.

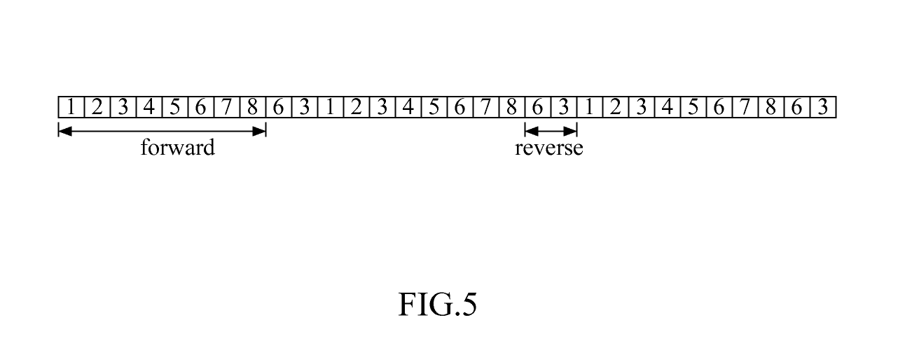

FIG. 5 shows another exemplary arrangement of the views of different view angles provided by the 3D image converter 11 and displayed on the display device 13 according to another embodiment of the present invention. One (horizontal) line on the display device 13 is shown in FIG. 5. In the exemplary embodiment, eight views, for example, from a left view angle toward a right view angle (represented by numerals 1 to 8) are arranged in (forward) order of view angle. After one set of views is arranged in forward order of view angle, another set of views (e.g., views 6 to 3) is subsequently arranged in reverse order of view angle. As shown in FIG. 4, views arranged in forward order (of view angle) and views arranged in reverse order (of view angle) are alternately arranged on a line of the display device 13. Compared with the preceding embodiment as illustrated in FIG. 3, the views arranged in reverse order of the present embodiment (FIG. 5) are intermittently arranged instead of being continuously arranged as in FIG. 4. It is noted that disparity between any two adjacent views in the reverse order is still less than the predetermined threshold mentioned above, and therefore allows for perceiving the two adjacent views as a stereoscopic vision.

Although specific embodiments have been illustrated and described, it will be appreciated by those skilled in the art that various modifications may be made without departing from the scope of the present invention, which is intended to be limited solely by the appended claims.

What is claimed is:

1. An autostereoscopic display system, comprising:
a three-dimensional (3D) image converter coupled to receive a plurality of views of different view angles, and configured to arrange the plurality of views; and
a display device coupled to receive the plurality of arranged views;
wherein the plurality of arranged views includes views arranged in forward order of view angle and views arranged in reverse order of view angle, the views in forward order and the views in reverse order being alternately arranged on each line of the display device.

2. The system of claim 1, further comprising a view generating device configured to generate the plurality of views based on subset of views.

3. The system of claim 2, wherein the view generating device comprises:
a depth estimation unit coupled to receive and process the subset of views, thereby generating disparity information about the subset of views; and
an image synthesizer configured to generate the plurality of views based on the disparity information.

4. The system of claim 3, wherein the image synthesizer comprises a depth-image-based rendering (DIBR) unit.

5. The system of claim 1, further comprising a lens array covering the display device, the lens array including a plurality of magnifying lenses, designed so that when viewed from different angles, different views of different view angles are magnified respectively.

6. The system of claim 5, wherein the lens array comprises a lenticular lens array.

7. The system of claim 1, wherein the views arranged in forward order are arranged from a left view angle toward a right view angle; and the views arranged in reverse order are arranged from a right view angle toward a left view angle.

8. The system of claim 1, wherein the views arranged in reverse order are continuously arranged.

9. The system of claim 1, wherein the views arranged in reverse order are intermittently arranged.

10. The system of claim 1, wherein disparity between any two adjacent views of the plurality of arranged views is less than a predetermined threshold that allows for perceiving the two adjacent views as a stereoscopic vision by a viewer.

11. An autostereoscopic display method, comprising:
receive a plurality of views of different view angles;
arranging the plurality of views; and
displaying the plurality of arranged views on a display device;
wherein the plurality of arranged views includes views arranged in forward order of view angle and views arranged in reverse order of view angle, the views in forward order and the views in reverse order being alternately arranged on each line of the display device.

12. The method of claim 11, further comprising a step of generating the plurality of views based on subset of views.

13. The method of claim 12, wherein the step of generating plurality of views comprises:
receiving and processing the subset of views to generate disparity information about the subset of views; and
generating the plurality of views based on the disparity information.

14. The method of claim 13, wherein the step of generating the plurality of views based on the disparity information is performed by a depth-image-based rendering (DIBR) unit.

15. The method of claim 11, wherein the display device is covered with a lens array, the lens array including a plurality of magnifying lenses, designed so that when viewed from different angles, different views of different view angles are magnified respectively.

16. The method of claim 15, wherein the lens array comprises a lenticular lens array.

17. The method of claim 11, wherein, the views arranged in forward order are arranged from a left view angle toward a right view angle; and the views arranged in reverse order are arranged from a right view angle toward a left view angle.

18. The method of claim 11, wherein the views arranged in reverse order are continuously arranged.

19. The method of claim 11, wherein the views arranged in reverse order are intermittently arranged.

20. The method of claim 11, wherein disparity between any two adjacent views of the plurality of arranged views is less than a predetermined threshold that allows for perceiving the two adjacent views as a stereoscopic vision by a viewer.
